(19) United States
(12) Patent Application Publication
(10) Pub. No.: US 2008/0162428 A1
(43) Pub. Date: Jul. 3, 2008

(54) METHOD AND SYSTEM FOR CREATING DYNAMIC FIELDS

(76) Inventor: Vishal Gaurav, Bokaro Steel City (IN)

Correspondence Address: SAP AG, 3410 HILLVIEW AVENUE, PALO ALTO, CA, 94304, US

(21) Appl. No.: 11/617,718

(22) Filed: Dec. 28, 2006

(51) Int. Cl. G06F 17/30; G06F 7/00

(52) U.S. Cl. 707/3

(57) ABSTRACT

A method and system for dynamically creating fields to query a data base. The dynamic fields' metadata for a selected condition type is retrieved. Dynamic fields are created for the selected condition type based on the retrieved metadata and the User Interface (UI) elements are generated for the created dynamic fields.

### TECHNICAL FIELD

Embodiments of the invention generally relate to computer systems, and more particularly, to a method and system for dynamically creating fields to query a database.

### BACKGROUND

Since the dawn of the computer age, computers have evolved and become more and more powerful. In our present day, computers have become indispensable in many fields of human endeavor including engineering design, machine and process control, information storage and retrieval, and office computing. One of the primary uses of computers is for information storage and retrieval.

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records are returned as the query result.

Graphical query interfaces have been developed that help a user to query a database. One problem with the existing graphical querying interfaces is that a user, who does not have detailed knowledge of the database relationships, may define a query that could return millions of records, or could define a query that returns no records. As a result, the user may spend time building a query only to find out after executing the query that the query did not return the desired data. The user must then guess at what changes to make to the query so that it returns the desired data.

Some graphical querying interfaces list all available columns in a database from which the user may select one or more columns to build a query. The user may also select a field in a column to further refine the query conditions. Building a query by selecting columns and records is a very tedious and time consuming process especially when the database being queried is very large and contains hundreds of columns and thousands of records.

Thus the result of the prior art is the generation of queries by a tedious and time consuming process that are not terribly useful because they return a dataset that is too large or too small to be useful.

### SUMMARY OF THE INVENTION

Embodiments of the invention are generally directed to a method and system for dynamically creating fields to query a data base. The dynamic fields metadata for a selected condition type is retrieved. Dynamic fields are created for the selected condition type based on the retrieved metadata and the user interface (UI) elements are generated for the created dynamic fields.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 illustrates a functional block diagram of a system for creating dynamic fields and building a query according to an embodiment of the invention.

FIG. 2 illustrates a flow diagram to explain the process flow for the creation of dynamic fields and building a query according to an embodiment of the invention.

FIG. 3 illustrates a user interface (UI) depicting the creation of dynamic fields according to an embodiment of the invention.

FIG. 4 illustrates the user interface of FIG. 3 showing results retrieved by a query built by input values provided by a user in the dynamic fields according to an embodiment of the invention.

FIG. 5 illustrates an exemplary block diagram of a system useful for implementing the invention according to an embodiment of the invention.

### DETAILED DESCRIPTION

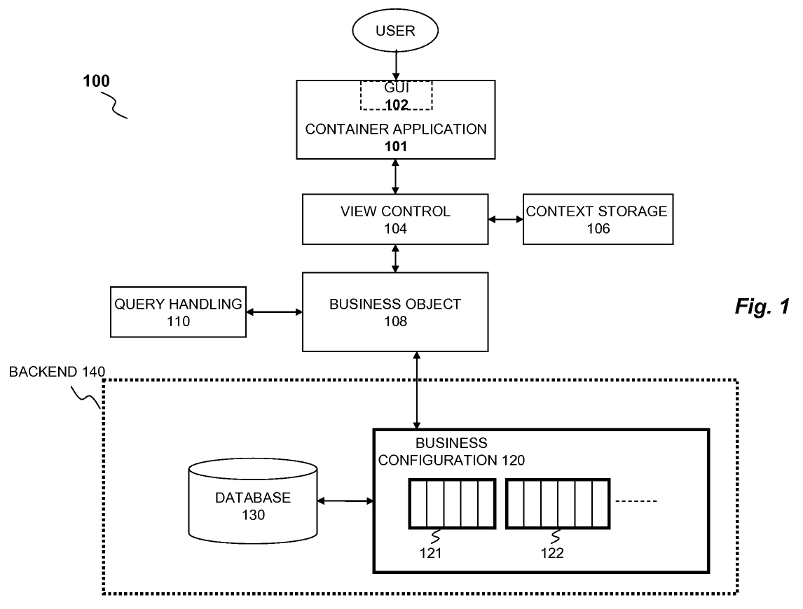

FIG. 1 illustrates a functional block diagram 100 of a system for creating dynamic fields and building a query according to a preferred embodiment of the invention. Business configuration 120 stores a number of condition types, for example, condition type 121.

According to one embodiment of the invention each condition type 121 generally includes a number of fields, each field being associated with a column in the database 130. Each field of a condition type 121 is typically a semantic key. The semantic keys of a condition type 121 may include one or more static fields wherein static fields are associated with the columns that are usually common across the database 130. A user 140 typically builds a query by specifying various logical conditions between the fields of a condition type 121. The query is then used to search and retrieve desired results from the database 130. The logical conditions between the fields of the condition type 121 may be Boolean conditions such as AND, OR, NOT, XOR or XNOR. The user 140 may create and configure user created condition types based upon the search requirements and store the user created condition types in the business configuration 120 or choose from a standard set of condition types provided by an application vendor.

According to an embodiment of the invention user 140 may select a condition type 121 from a list of condition types, including user created condition types, presented to him by the GUI 102. Responsive to the user 140 selecting a condition type 121, application 101 retrieves the metadata for all the semantic keys of the selected condition type 121 from the business configuration 120 and saves the metadata in the business object 108. The metadata for each field of a condition type 121 may include a UT type, name of the field, type of field, label of field, tool tip or sync code. According to one embodiment of the invention the business object 108 may include a root node and a property valuation node wherein the root node stores the static fields and the property valuation node stores rest of the semantic keys. The semantic keys metadata may be stored in a tabular format with the metadata for each semantic key being stored as one separate record in a row of a table. View control 104 usually creates the UI elements for all the semantic keys of the selected condition type 121 from the retrieved metadata. Creation of UI elements typically includes dynamically building a context, dynamically creating a form having dynamic input fields for the retrieved semantic keys and push buttons for performing tasks and dynamically associating the push buttons with actions. A context is created for the selected condition type 121 and stored in the context storage 106. A context is created for session maintenance so that same data need not be retrieved repeatedly at the change of each user screen in GUI 102. The tasks for which push buttons are created include clearing the fields, saving a query, deleting a query, modifying a query and searching based upon a created query. The push buttons may be associated with actions such as mouse click or press of a button on a key board. The user 140 may enter values in each of the created dynamic input fields to build the query and search the database 130 and retrieve the desired results.

Each semantic key is bound to a generic query 110 in order to build a query for the selected condition type 121. The generic query 110 includes a number of empty key-value pairs. The key field of a key-value pair is bound to a semantic key of the selected condition type 121 and the value field of the key-value pair is bound to the dynamic input field for the semantic key in the GUI 102. The values entered in a dynamic input field for a semantic key are thus bound to the value field of the key-value pair bound to the semantic key. Similarly each semantic key of the selected condition type 121 and its corresponding dynamic input field is bound to a key-value pair of the generic query 1 10. The user 140 may then specify logical conditions between the key-value pairs to build the required query. The user 140 may also choose to ignore one or more of the key-value pairs and choose to build a query based upon only few of the semantic keys of the selected condition type 121. The built query may then be used to search the database 130 and retrieve desired results.

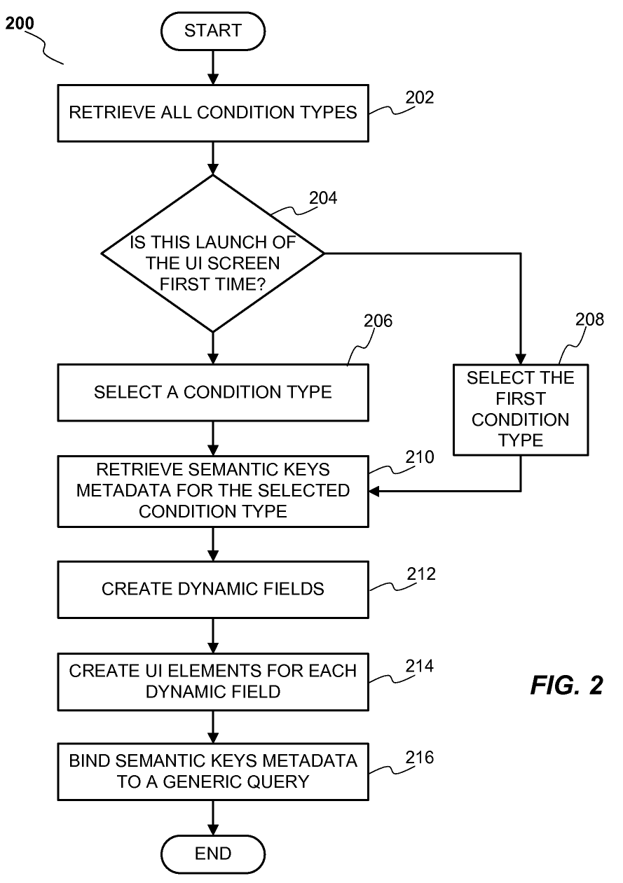

FIG. 2 illustrates a flow diagram to explain the process flow 200 for the creation of dynamic fields and building a query according to an embodiment of the invention. In process block 202, all the condition types labels are retrieved from the business configuration 120 and presented to the user as a list. The condition types include standard and user created condition types. In decision block 204, if the UI screen has been launched for the first time, process flow 200 continues to process block 208 wherein the first condition type from the list is automatically selected and the process flow 200 continues to process block 210. Returning to decision block 204. If a launch of the UI screen is not for the first time, process flow 200 continues to process block 206 wherein the required condition type is selected by the user. In process block 210 the metadata for all the semantic keys of the selected condition type is retrieved from the business configuration 120. Responsive to the retrieval of metadata in process block 210, dynamic input fields are created for each semantic key in process block 212. UI elements for the created dynamic input fields are then generated in process block 214 and are displayed along with other UI elements such as push buttons etc by GUI 102. In process block 216, the semantic keys and their corresponding input fields are bound to a generic query.

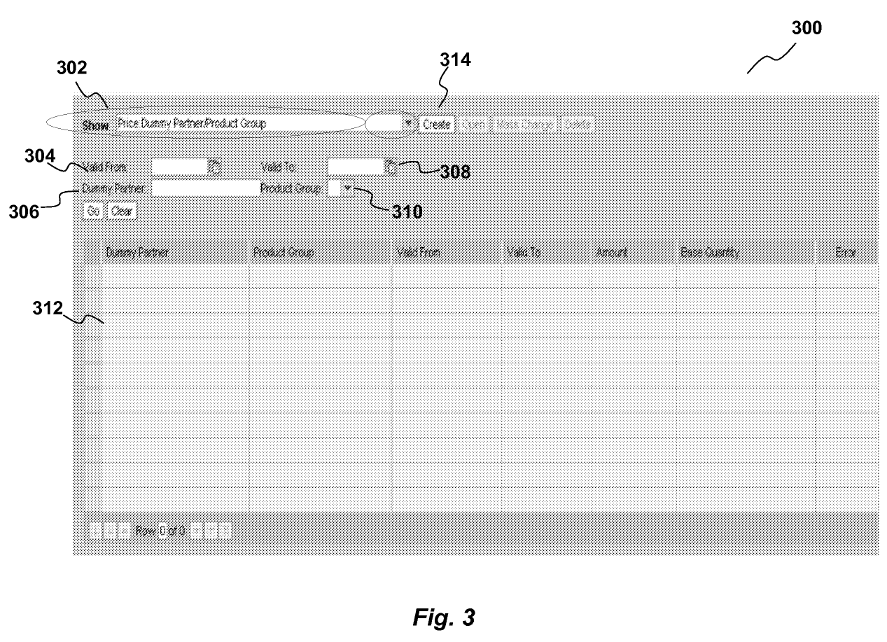

FIG. 3 illustrates a user interface (UI) 300 depicting the creation of dynamic fields according to an embodiment of the invention. The user is presented with a drop down list 302 containing all the condition types stored in the business configuration 120. Each condition type in the drop down list 302 is displayed with the corresponding label. The condition type “Price: Dummy Partner/Product Group” is the currently selected condition type in the drop down list 302. As soon as the user selects the condition type, the metadata for all the semantic keys of the selected condition are retrieved from the business configuration 120, the UI elements are created and the dynamic fields for the semantic key fields 304, 306, 308 and 310 are displayed as a form in the UI 300. Valid From 304 and Valid To 308 are the static fields. The user may now enter or select a value for one or more of the dynamic fields to build the query. Each of the dynamic fields 304, 306, 308 and 310 and a corresponding dynamic fields value is bound to a key-value pair of the generic query 110. The user may now specify logical conditions between the bound key-value pairs to build the query. The user may be presented with various push buttons to perform various tasks such as create/edit logical conditions, delete query or edit query. For example push button 314 enables the user to specify logical conditions. Finally the user may initiate a query to search the database by clicking the ‘Go’ push button. The results of the search may be displayed in a tabular format as in table 312.

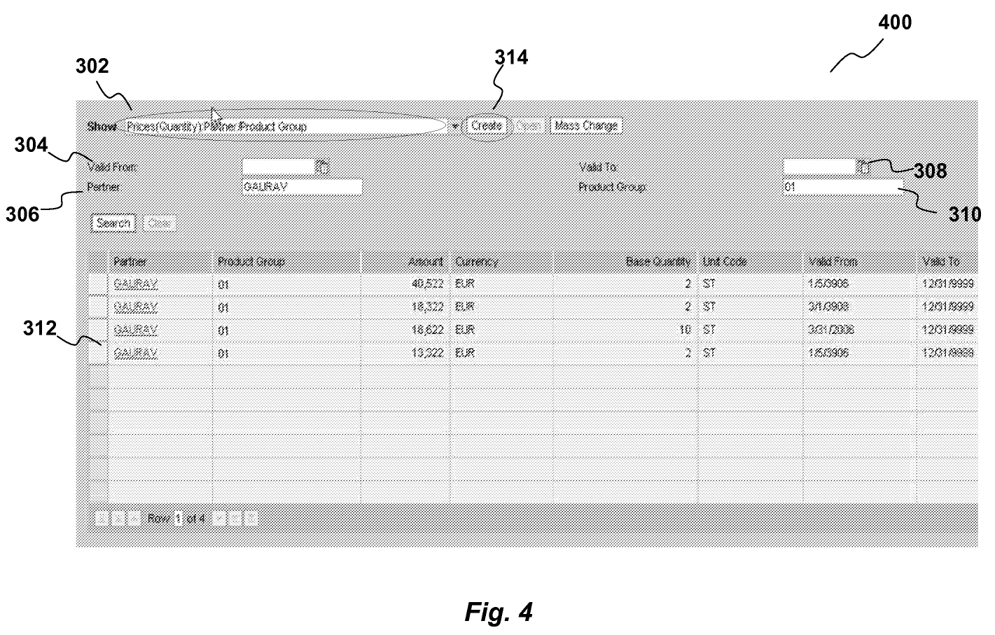

FIG. 4 illustrates the user interface of FIG. 3 showing results retrieved by a query built by input values provided by a user in the dynamic fields according to an embodiment of the invention. Values “Gaurav” and “01” have been entered for the dynamic fields Dummy partner 306 and Product group 310 respectively. Now for example an ‘AND’ logical condition is specified between the Dummy partner 306 and Product Group 310. The generic query structure now is (“Dummy partner=Gaurav” AND “Product Group=01”). Static fields 304 and 308 are ignored since they contain no values. The query is initiated to search the database 130 and only those records are retrieved that have “Dummy partner=Gaurav” AND “Product group=01”. The results of the search may bee seen in the table 312. As can be seen, only the records having the value “Gaurav” under field name “Partner” and value “01” under field name “Product Group” are displayed.

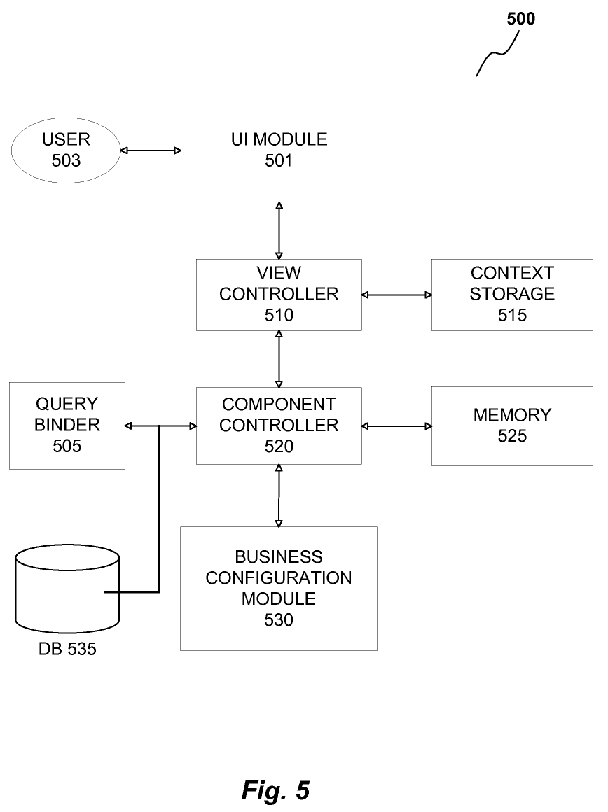

FIG. 5 illustrates an exemplary block diagram of a system 500 useful for implementing the invention according to an embodiment of the invention. The user 503 interacts with the system 500 through the UI module 501. The business configuration module 530 stores the condition types. The component controller 520 retrieves the metadata of all the semantic keys in a selected condition type, stores each semantic key metadata as a separate record in the memory 525 and creates dynamic fields for each semantic key. The view controller 510 builds a session, creates a context for the session and stores the context in context storage 515. The view controller 510 then creates the UI elements for the created dynamic fields and displays them to the user through the UI module 501. The Query binder 505 binds the key-value pairs of the generic query to the dynamic fields to build a query. The component controller may then search the database 535 based on the built query and retrieve the desired results.

The particular methods associated with embodiments of the invention are described in terms of computer software and hardware with reference to a flowchart. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
retrieving a dynamic field metadata for a condition type;
creating a dynamic field for the condition type based on the dynamic field metadata; and
creating a user interface (UI) element for the dynamic field.

2. The method of claim 1, wherein the condition type comprises a table having a number of fields.

3. The method of claim 2, wherein the fields comprise at least one static field.

4. The method of claim 1, further comprising retrieving the condition type.

5. The method of claim 3, wherein the condition type is retrieved responsive to initiating an application.

6. The method of claim 1, wherein the dynamic field metadata is selected from a group comprising UI type, name of field, type of field, label, tool tip and sync code.

7. The method of claim 1, wherein the step of creating UI elements comprises:
dynamically building a context;
dynamically creating a form having the dynamic field and at least one push button for performing a task; and
dynamically associating the at least one push button with an action.

8. The method of claim 7, wherein the context stores the dynamic field metadata of the condition type for a session.

9. The method of claim 7, wherein the task is selected from a group comprising clearing the fields, saving a query, deleting a query, modifying a query and searching based upon a created query.

10. The method of claim 1, further comprising:
listing the condition type in a user interface; and
selecting the condition type responsive to initiating an application.

11. The method of claim 1, further comprising binding the dynamic fields metadata to a generic query.

12. A system comprising:
a business configuration module, the business configuration module storing a condition type;
a component controller for retrieving a dynamic field metadata for the condition type and creating a dynamic field based on the dynamic field metadata; and
a view controller for creating a user interface element for the dynamic field and displaying the dynamic field in a user interface.

13. The system of claim 12, wherein the business configuration module stores the condition type as a table having a number of fields.

14. The system of claim 13, wherein the fields comprise at least one static field.

15. The system of claim 12, further comprising a memory unit storing the dynamic field metadata as a record.

16. The system of claim 12, further comprising a context storage unit coupled to the view controller, the context storage unit storing a context for a session built by the view controller.

17. The system of claim 12, wherein the dynamic field metadata is selected from a group comprising UI type, name of field, type of field, label, tool tip and sync code.

18. The system of claim 12, further comprising a query binder for binding the dynamic field metadata to a generic query.

19. A machine-accessible medium that provides instructions that, when executed by a machine, cause the machine to perform operations comprising:
retrieving a dynamic field metadata for a condition type;
creating a dynamic field for the condition type based on the dynamic field metadata; and
creating a user interface (UI) element for the dynamic field.

20. The machine-accessible medium of claim 19, wherein the condition type comprises a table having a number of predetermined fields.

21. The machine-accessible medium of claim 20, wherein the fields comprise at least one static field.

22. The machine-accessible medium of claim 19, further providing instructions which when executed by the machine, cause the machine to perform further operations comprising retrieving the condition type.

23. The machine-accessible medium of claim 19, wherein the condition type is retrieved responsive to initiating an application.

24. The machine-accessible medium of claim 19, wherein the dynamic field metadata is selected from a group comprising UI type, name of field, type of field, label, tool tip and sync code.

25. The machine-accessible medium of claim 19, wherein the step of creating UI elements comprises:
dynamically building a context;
dynamically creating a form having the dynamic field and at least one push button for performing a task; and
dynamically associating the push button with an action.

26. The machine-accessible medium of claim 25, wherein the context stores the dynamic field metadata of the condition type for a session.

27. The machine-accessible medium of claim 25, wherein the task is selected from a group comprising clearing the fields, save a query, delete a query modifying a query and search based upon a created query.

28. The machine-accessible medium of claim 19, further providing instructions which when executed by the machine, cause the machine to perform further operations comprising:
list the condition type in a user interface; and
selecting the condition type responsive to initiating an application.

29. The machine-accessible medium of claim 19, further providing instructions which when executed by the machine, cause the machine to perform further operations comprising binding the dynamic fields metadata to a generic query.
